(19) United States
(12) Patent Application Publication
(10) Pub. No.: US 2026/0141296 A1
(43) Pub. Date: May 21, 2026

(54) NON-TRANSITORY COMPUTER-READABLE MEDIUM, TRAINING METHOD, AND INFORMATION PROCESSING APPARATUS

(71) Applicant: Fujitsu Limited, Kawasaki-shi (JP)

(72) Inventors: Yuichi ISHIDA, Kawasaki (JP); Yuma ICHIKAWA, Kawasaki (JP); Aki DOTE, Kawasaki (JP)

(73) Assignee: Fujitsu Limited, Kawasaki-shi (JP)

(21) Appl. No.: 19/178,952

(22) Filed: Apr. 15, 2025

(30) Foreign Application Priority Data
May 21, 2024 (JP) 2024-082750

(51) Int. Cl. G06N 20/00

(52) U.S. Cl. CPC G06N 20/00

(57) ABSTRACT

There is provided a non-transitory computer-readable medium having stored therein a training program for causing a computer to execute a process, in training a machine learning model capable of generating self-sampled data based on a probability distribution estimated for sampled data. The process includes generating the self-sampled data from the machine learning model in process of training, and training the machine learning model so that a third loss function becomes small. The third loss function includes a first loss function of unsupervised training based on the sampled data and a second loss function of supervised training based on the sampled data and the self-sampled data.

### CROSS-REFERENCE TO RELATED APPLICATION

This application is based upon and claims the benefit of priority of Japanese Patent Application No. 2024-082750 filed on May 21, 2024, the entire contents of which are incorporated herein by reference.

### FIELD

A certain aspect of the present embodiments relates to a non-transitory computer-readable medium, a learning method, and an information processing apparatus.

### BACKGROUND

There have been disclosed techniques for generating generation models by performing machine learning on probability distributions (see, for example, Non-Patent Document 1: Huang, L. and Wang, “Accelerated monte carlo simulations with restricted boltzmann machines” Physical Review B, 95 (3): 035105, and Non-Patent Document 2: Midgley, L. I., Stimper, V., Simm, G. N., Sch″olkopf, B., and Hern′andez-Lobato, J. M. (2022). Flow annealed importance sampling bootstrap. arXiv preprint arXiv: 2208.01893.).

### SUMMARY

According to an aspect of the present disclosure, there is provided a non-transitory computer-readable medium having stored therein a training program for causing a computer to execute a process, in training a machine learning model capable of generating self-sampled data based on a probability distribution estimated for sampled data. The process includes generating the self-sampled data from the machine learning model in process of training, and training the machine learning model so that a third loss function becomes small. The third loss function includes a first loss function of unsupervised training based on the sampled data and a second loss function of supervised training based on the sampled data and the self-sampled data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1A is a functional block diagram illustrating the overall configuration of an information processing apparatus.

FIG. 1B is a hardware configuration diagram of the information processing apparatus.

FIG. 2 is a flowchart illustrating an example of the operation of the information processing apparatus.

FIGS. 3A and 3B are diagrams illustrating learning results.

### DETAILED DESCRIPTION

It is difficult to generate a generation model with high accuracy in both learning with data where sampled data is prepared and learning without data where no sampled data is prepared.

In one aspect, an object of the present disclosure is to provide a non-transitory computer-readable medium, a learning method, and an information processing apparatus capable of generating a generation model with high accuracy.

In the field of statistics, techniques have been proposed for sampling from a probability distribution under a situation where a functional form other than a normalization constant (distribution function) of the probability distribution is given. For example, techniques for sampling from the probability distribution have been proposed in the field of proteins. Specifically, in the following equation (1), p (x) is a probability distribution. In the following equation (1), Z is a normalization constant. In the following equation (1), it is difficult to evaluate the value of Z, and the energy function H (x) is available in a realistic calculation time.

$$p ( x ) = \frac{1}{Z} {e}^{- H ( x )} , Z = \int {dxe}^{- H ( x )} \qquad ( 1 )$$

In the field of machine learning, techniques (generation models) for modeling unknown complex probability distributions by a machine learning model q (x) have been developed. In particular, a generation model q_{θ} (x) characterized by a parameter θ, as illustrated in the following equation (2), has been developed as a mainstream.

$${q}_{θ} ( x ) = \frac{1}{Z ( θ )} {e}^{- {H}_{θ} ( x )} , Z ( θ ) = \int {dxe}^{- {H}_{θ} ( x )} \qquad ( 2 )$$

In recent years, methodologies have progressed to apply machine learning techniques and train generation models under conditions where a functional form other than the normalization constant of the probability distribution is given. For example, a framework has been proposed to speed up sampling under the situation where the functional form other than the normalization constant of the probability distribution is given. A specific example will be described below.

First, learning (i.e., learning with data) in the case where sampled data is prepared in advance will be described. First, supervised learning of the learning with data will be described. In the supervised learning, an objective energy function H (x) and sampled data D_{data} of the distribution are prepared. The sampled data D_{data} is expressed by the following equation (3).

$${D}_{data} = {\{ {x}_{μ} \}}_{μ = 1}^{P} \qquad ( 3 )$$

The sampled data D_{data} satisfies the following expression (4). Since “E” in the following equation (4) represents expectation, a left side of the following equation (4) represents an expected value obtained by the histogram of the D_{data}.

$${𝔼}_{{D}_{data}} A ( x ) ≡ {\sum }_{μ = 1}^{P} \frac{A ( {x}^{μ} )}{P} \qquad ( 4 )$$

In the supervised learning, a proper loss function is defined by using the objective energy function H (x) as teacher data, and a parameter θ is determined so that the loss function becomes small. For example, in Huang, L. and Wang, “Accelerated monte carlo simulations with restricted boltzmann machines” Physical Review B, 95 (3): 035105, the parameter is updated by optimizing the following equation (7) using the teacher data and the forward f-divergence of the following equation (5) (f-divergence is the following equation (6)).

$$f ( ω ) = {ω ( log ω )}^{2} \qquad ( 5 )$$

$${D}_{f} ( p \vert \vert q ) = \int q ( x ) f ( \frac{{p ( x )}^{3}}{q ( x )} ) dx \qquad ( 6 )$$

$$L ( θ ; D , H ) = {𝔼}_{{D}_{data}} [ {( H ( x ) - {H}_{θ} ( x ) )}^{2} ] \qquad ( 7 )$$

Next, unsupervised learning of the learning with data will be described. In the unsupervised learning, since the objective energy function H (x) is not used as the teacher data, sampled data represented by the above-described equation (3) is prepared. The parameter θ is determined by using a maximum likelihood method so that the loss function of the following equation (8) becomes small.

$$L ( θ ; D ) = - {𝔼}_{{D}_{data}} [ log {q}_{θ ( x )} ] \qquad ( 8 )$$

Next, learning (i.e., learning without data) in the case where sampled data is not prepared in advance will be described. In this case, only the functional form H (x) other than the normalization constant of the objective probability distribution is available. For example, in Midgley, L. I., Stimper, V., Simm, G. N., Sch″olkopf, B., and Hern′ andez-Lobato, J. M. (2022). Flow annealed importance sampling bootstrap. ar Xiv preprint arXiv: 2208.01893., the loss functions are expressed by the following equations (9) and (10). The following equation (10) represents the self-sampled data. In the following equation (10), “x_{μ} to q_{θ} (x)” represents a random variable according to q_{θ} (x).

$$L ( θ ; H ) = {𝔼}_{{q}_{θ} ( x )} [ log \frac{p ( x )}{{q}_{θ} ( x )} ] \approx {𝔼}_{{D}_{self}} [ log \frac{p ( x )}{q ( x )} ] \qquad ( 9 )$$

$${D}_{self} = {\{ {x}_{μ} \vert {x}_{μ} ∼ {q}_{θ} ( x ) \}}_{μ = 1}^{P} \qquad ( 10 )$$

Advantages and disadvantages of the above-described learning with data and learning without data will be described below.

First, the supervised learning of the learning with data will be described. The supervised learning directly utilizes the functional form H (x), which has the advantage of high regression performance of energy. On the other hand, the disadvantage is that the generalization performance is low, and it is difficult to generate the sampled data of the following equation (11) from the learned generation model q_{θ} (x) in a realistic time. For example, it is difficult to acquire sampled data from the generation model q_{θ} (x) in the realistic time using a Markov chain Monte Carlo method or the like.

$${\{ {x}_{m} \}}_{m = 1}^{M} \qquad ( 11 )$$

Next, the unsupervised learning of the learning with data will be described. The unsupervised learning has advantages that learning is possible even in a situation where the functional form H (x) is not necessary and since additional sampled data (self-sampled data) of the generation model q_{θ} (x) is used in process of learning of the parameter θ, a distribution q_{θ} (x) that is easy to implicitly sample is learned. On the other hand, the unsupervised learning has a disadvantage that the regression performance is low because it does not directly utilize the functional form H (x).

Next, the learning without data will be described. The learning without data has an advantage that learning can be performed only with the objective energy function H (x) because the sampled data D_{data} of the learning data is unnecessary. On the other hand, the learning without data has a disadvantage that mode collapse occurs. The mode collapse means that only one mode of a probability distribution with multiple modes (a multi-peaked probability distribution with multiple peaks) can be learned.

For the above reasons, it is difficult to generate a generation model in both the learning with data and the learning without data. Therefore, in the following embodiments, an example in which a generation model can be generated will be described.

### First Embodiment

First, the principle of the present embodiment will be described.

Information on the objective energy function H (x) is added as regularization to the unsupervised learning of the learning with data, as in the supervised learning of the learning with data, to generate a model with better generalization performance with high regression performance of energy. Then, the self-sampled data is added to the loss of the supervised learning using an implicit regularization where the generation model q θ (x) is a distribution that is easy to sample due to the utilization of the self-sampled data for unsupervised learning. In addition, since mode collapse may occur when only the self-sample D_{self} is included in the loss of supervised learning as in the learning without data, the regression performance of a self-sample region generated by the model other than the sampled data is improved.

The above can be summarized as follows. Specifically, it is assumed that a machine learning model (generation model) capable of generating additional sampled data (self-sampled data) is learned based on a probability distribution estimated for the sampled data. The self-sampled data generated by the machine learning model in process of learning is acquired. Next, the machine learning model is trained so that a loss function, which includes another loss function of the unsupervised learning based on the sampled data and the other loss function of the supervised learning based on the sampled data and additional sampled data, becomes small.

For example, the loss function of the following equation (12) is minimized. In the following equation (12), “t” represents a time characterizing one step of the learning algorithm. Lᵤₙₛᵤₚ (θ; D) represents a loss function of the unsupervised learning. Λᵤₙₛᵤₚ represents a coefficient of the loss function of the unsupervised learning. Lₛᵤₚ (θ; D, H) represents a loss function of the supervised learning. Λₛᵤₚ (t) represents a coefficient of the loss function of the supervised learning. “sup” stands for “Supervised” and represents “supervised”. “Unsup” stands for “Unsupervised” and represents “unsupervised”.

$$L ( θ ; {D}_{data} , {D}_{self ,} H ) = {λ}_{unsup} ( t ) {L}_{unsup} ( θ ; {D}_{data} ) + {λ}_{sup} ( t ) {L}_{sup} ( θ ; \{ {D}_{data} , {D}_{self} \} , H ) \qquad ( 12 )$$

By employing such a method, an element of the supervised learning of the learning with data can be incorporated, so that the regression performance of energy is increased by directly using the functional form H(x). Next, since the element of the unsupervised learning of the learning with data can be incorporated, the distribution q_{θ} (x) that is easy to implicitly sample is learned by using the self-sampled data. From the above, it is possible to generate a generation model with high accuracy.

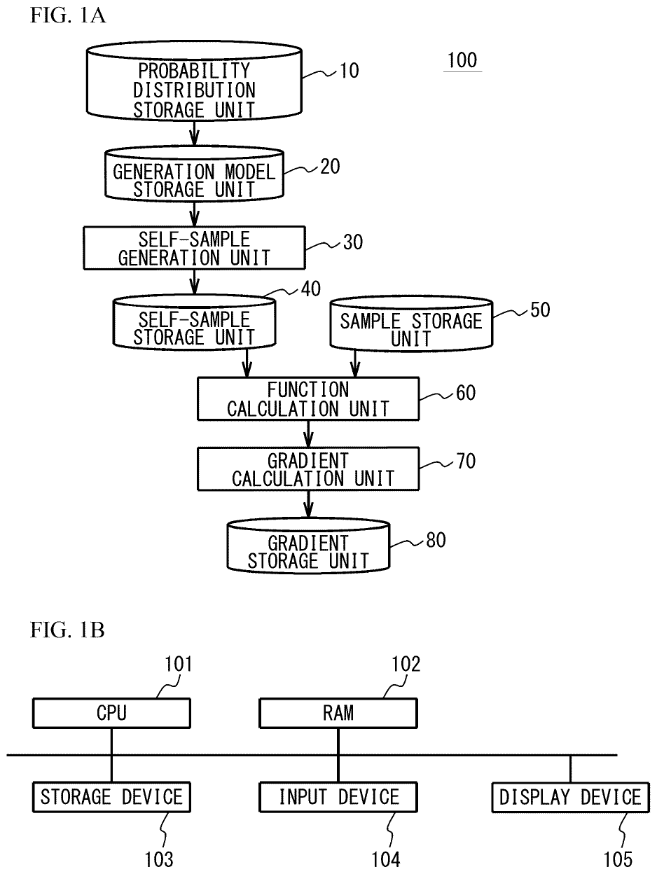

Next, the structure of the apparatus for realizing the above-described principle of solution will be described. FIG. 1A is a functional block diagram illustrating the overall configuration of an information processing apparatus 100 according to the present embodiment. The information processing apparatus 100 is a server for optimization processing or the like. As illustrated in FIG. 1A, the information processing apparatus 100 functions as a probability distribution storage unit 10, a generation model storage unit 20, a self-sample generation unit 30, a self-sample storage unit 40, a sample storage unit 50, a function calculation unit 60, a gradient calculation unit 70, a gradient storage unit 80, and the like.

FIG. 1B is a hardware configuration diagram of the information processing apparatus 100. As illustrated in FIG. 1B, the information processing apparatus 100 includes a CPU 101, a RAM 102, a storage device 103, an input device 104, a display device 105, and the like.

The CPU (Central Processing Unit) 101 is a central processing unit. The CPU 101 includes one or more cores. The RAM (Random Access Memory) 102 is a volatile memory that temporarily stores programs executed by the CPU 101, data processed by the CPU 101, and the like. The storage device 103 is a nonvolatile storage device. As the storage device 103, for example, a ROM (Read Only Memory), a solid state drive (SSD) such as a flash memory, a hard disk driven by a hard disk drive, or the like can be used. The storage device 103 stores a learning program. The input device 104 is a device for a user to input necessary information, and is a keyboard, a mouse, or the like. The display device 105 is a display device for displaying the learning result on a screen. The CPU 101 executes the learning program, thereby implementing each unit of the information processing apparatus 100. Note that hardware such as a dedicated circuit may be used as each unit of the information processing apparatus 100.

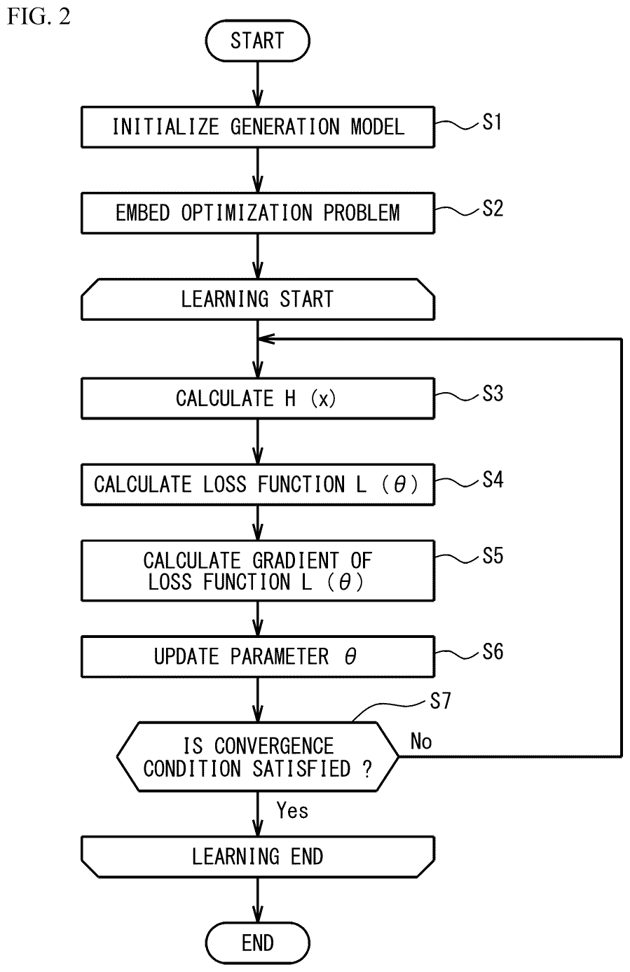

FIG. 2 is a flowchart illustrating an example of the operation of the information processing apparatus 100 when the generation model is machine-learned. The machine learning of the generation model will be described below.

As illustrated in FIG. 2, the function calculation unit 60 initializes the generation model (step S1). Specifically, the function calculation unit 60 sets a model parameter stored in the generation model storage unit 20 to a predetermined initial value.

Next, the function calculation unit 60 embeds an optimization problem (step S2). Specifically, the self-sample generation unit 30 first acquires the sampled data (the above-described equation (3)) stored in the sample storage unit 50. Next, the self-sample generation unit 30 generates the self-sampled data from the generation model (i.e., the generation model whose model parameter is the initial value) stored in the generation model storage unit 20. Next, the function calculation unit 60 generates the loss function of the above-described equation (12).

Next, the function calculation unit 60 calculates H (x) using the sampled data and the self-sampled data acquired in step S2 (step S3).

Next, the function calculation unit 60 calculates a loss function L (θ) in which the loss function of the above-described equation (12) is minimized, using H (x) acquired in step S3 (step S4).

Next, the gradient calculation unit 70 calculates the gradient of the loss function L (θ) (step S5). The gradient calculated in step S5 is stored in the gradient storage unit 80.

Next, the function calculation unit 60 updates the parameter θ using the gradient stored in the gradient storage unit 80 (step S6).

Next, the function calculation unit 60 determines whether the convergence condition is satisfied (step S7). For example, it is determined whether the loss function L (θ) has not become smaller than a specified value even if step S6 is repeatedly executed. If the determination result in step S7 is “No”, the process is executed again from step S3.

If the determination result in step S7 is “Yes”, the execution of the flowchart ends. In this case, the generation model storage unit 20 stores the model parameter in the case where the loss function is the smallest. The display device 105 may also display the learning result such as the model parameter stored in the generation model storage unit 20.

When a machine-learned generation model is actually used, the self-sample generation unit 30 acquires the sampled data (the above-described equation (3)) that is obtained from the probability distribution stored in the probability distribution storage unit 10 and stored in the sample storage unit 50. Next, the self-sample generation unit 30 generates the self-sampled data from the generation model stored in the generation model storage unit 20. This allows the generation model to be used.

The following describes the verification of the effect of the present embodiment.

A restricted Boltzmann machine H_{θ} was used as the generation model. The loss function is expressed by the following equation (13).

$$L ( θ ; {D}_{data} , {D}_{self} , H ) = \frac{1}{\vert {D}_{data} + {D}_{self} \vert} {{Σ}_{x ∈ \{ {D}_{data} , {D}_{self} \}} ( βH ( x ) - {H}_{θ} ( x ) )}^{2} \qquad ( 13 )$$

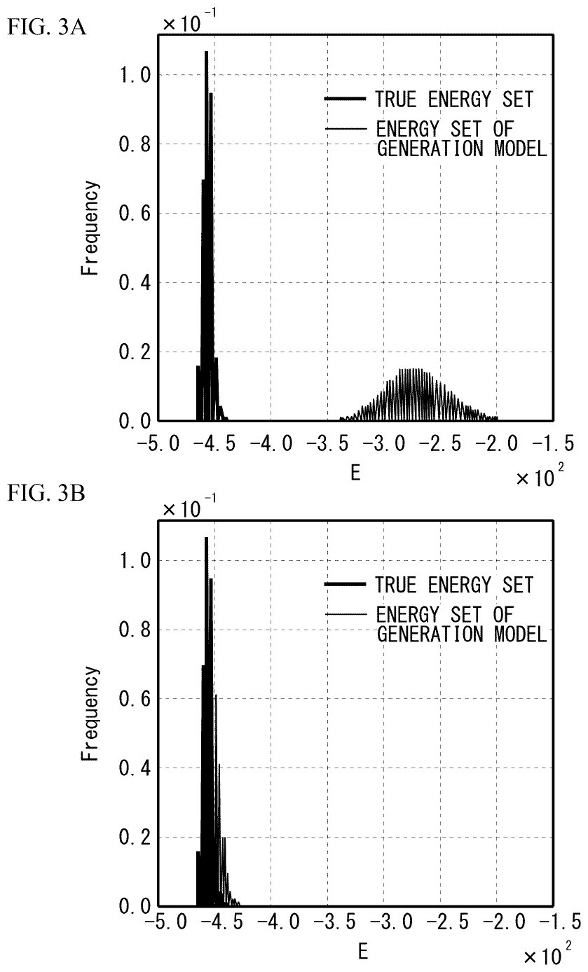

FIG. 3A illustrates the result of general learning with data in case of D_{self}=0. FIG. 3B illustrates the result of the learning according to the present embodiment. In FIGS. 3A and 3B, thick lines represent a histogram of a true energy set (energy distribution in a state sampled from the objective probability distribution) H_{data}={H (x)|x^{˜}p (x)}, and the thin lines represent a histogram of an energy set H_{self}={H (x)|x^{˜}q_{θ} (x)} of the generation model. In FIG. 3A, H_{self} represents an energy distribution in a state sampled from the generation model generated by the general learning with data. In FIG. 3B, H_{self} represents an energy distribution in a state sampled from the generation model generated by the learning according to the present embodiment. In FIG. 3A, a peak region of the thick lines is separated from a peak region of the thin lines. In contrast, in FIG. 3B, the peak region of the thick lines and the peak region of the thin lines are almost coincident with each other.

Therefore, a distance of the following equation (14) was calculated. The distance in the following equation (14) is a KL divergence, and means a distance between the objective probability distribution and the energy distribution of the state sampled from the objective probability distribution. In the general learning with data, W₁=184 was obtained, and in the learning according to the present embodiment, W₁=5.05 was obtained. From this result, it is understood that the energy distribution in the state sampled from the generation model generated by the learning according to the present embodiment has a 36.4 times improved distance between the objective probability distribution and the energy distribution in the state sampled from the objective probability distribution than the energy distribution in the state sampled from the generation model generated by the general learning with data.

$${W}_{1} ( p , {q}_{θ} ) = {\int }_{- ∞}^{+ ∞} \vert P - {Q}_{θ} \vert \qquad ( 14 )$$

In the above example, the effect was confirmed for the restricted Boltzmann machine He as an example, but the present embodiment can be applied to other energy-based models, and flow-based models, autoregressive models and the like in which the likelihood can be easily evaluated.

In the above embodiment, the self-sample generation unit 30 is an example of a self-sample generation unit that generates the self-sampled data from the machine learning model in process of learning, in the learning of the machine learning model capable of generating self-sampled data based on the probability distribution estimated for the sampled data. The function calculation unit 60, the gradient calculation unit 70, and the gradient storage unit 80 are an example of a learning unit that perform learning of the machine learning model so that a third loss function including a first loss function of the unsupervised learning based on the sampled data and a second loss function of the supervised learning based on the sampled data and the self-sampled data becomes small.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A non-transitory computer-readable medium having stored therein a training program for causing a computer to execute a process, in training a machine learning model capable of generating self-sampled data based on a probability distribution estimated for sampled data, the process comprising:
generating the self-sampled data from the machine learning model in process of training; and
training the machine learning model so that a third loss function becomes small, the third loss function including a first loss function of unsupervised training based on the sampled data and a second loss function of supervised training based on the sampled data and the self-sampled data.

2. The non-transitory computer-readable medium according to claim 1, wherein
the second loss function includes an energy function calculated from the self-sampled data as a penalty.

3. A training method causing a computer to execute a process, in training a machine learning model capable of generating self-sampled data based on a probability distribution estimated for sampled data, the process comprising:
generating the self-sampled data from the machine learning model in process of training; and
training the machine learning model so that a third loss function becomes small, the third loss function including a first loss function of unsupervised training based on the sampled data and a second loss function of supervised training based on the sampled data and the self-sampled data.

4. The training method according to claim 3, wherein
the second loss function includes an energy function calculated from the self-sampled data as a penalty.

5. An information processing apparatus comprising:
a memory;
a processor coupled to the memory and the processor configured to:
generate, in training a machine learning model capable of generating self-sampled data based on a probability distribution estimated for sampled data, the self-sampled data from the machine learning model in process of training; and
train the machine learning model so that a third loss function becomes small, the third loss function including a first loss function of unsupervised training based on the sampled data and a second loss function of supervised training based on the sampled data and the self-sampled data.

6. The information processing apparatus according to claim 5, wherein
the second loss function includes an energy function calculated from the self-sampled data as a penalty.
